(19) United States
(12) Patent Application Publication
(10) Pub. No.: US 2009/0213039 A1
(43) Pub. Date: Aug. 27, 2009

(54) Display device

(75) Inventor: Manabu Ito, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 12/072,036

(22) Filed: Feb. 21, 2008

(51) Int. Cl. G09G 3/00

(52) U.S. Cl. 345/30

(57) ABSTRACT

One embodiment of the present invention is a display device being visible from both sides, including a substantially transparent semiconductor circuit having a substantially transparent thin film transistor on one surface of a substantially transparent substrate and a wiring made of a substantially transparent conductive material, the wiring having an electric contact point electrically connected to the transistor, and a display element being driven by the semiconductor circuit.

### BACKGROUND OF THE INVENTION

1. Field Of the Invention

The present invention is related to a display device being visible from both sides.

2. Description Of the Related Art

A thin film transistor having an amorphous silicon or a polycrystal silicon has been generally used for a transistor for driving an electronic device. However, since the amorphous silicon and the polycrystal silicon are not transparent and are optically sensitive in the region of visible light, a light shielding film is necessary. Therefore, since a semiconductor circuit including a thin film transistor, a wiring thereof and the like become problematic in terms of visibility, the semiconductor circuit has been arranged in a back side of an observation side of a display element.

On the other hand, a display using a substantially transparent transistor and a substantially transparent semiconductor circuit has been developed. An image display device using a substantially transparent transistor and a substantially transparent semiconductor circuit has been proposed. (For example, see patent document 1) This image display device is effective as a display being visible from one side. However, a display being visible from both sides has not yet been realized.
[Patent Document 1] JP-A-2004-14982

### SUMMARY OF THE INVENTION

One embodiment of the present invention is a display device being visible from both sides, including a substantially transparent semiconductor circuit having a substantially transparent thin film transistor on one surface of a substantially transparent substrate and a wiring made of a substantially transparent conductive material, the wiring having an electric contact point electrically connected to the transistor, and a display element being driven by the semiconductor circuit.

### BRIEF DESCRIPTION OF THE DRAWINGS

FIG. 1 is a schematic partial cross-sectional diagram of an example of a display device of the present invention.

FIG. 2 is a schematic partial cross-sectional diagram of an example of a display device being visible from both sides with a reflection type display element of the present invention.

FIG. 3 is a schematic partial cross-sectional diagram of an example of a substantially transparent semiconductor circuit.

FIG. 4 is a schematic partial cross-sectional diagram of another example of a display device being visible from both sides with a reflection type display element of the present invention.

FIG. 5(a) is an explanatory figure of an example of a displayed image, the image being obtained by observing a display device being visible from both sides of the present invention from a direction (a).

FIG. 5(b) is an explanatory figure of an example of a displayed image, the image being obtained by observing a display device being visible from both sides of the present invention from a direction (b).

In these drawings, 1 is a substantially transparent substrate; 10 and 10a each are a substantially transparent semiconductor circuit; 11 is a gate electrode; 12 is an auxiliary capacitor electrode; 13 is a gate insulator; 14 and 14a each are a semiconductor active layer; 15 is a source electrode; 16 is a drain electrode; 17 is an interlayer dielectric; 18 is a pixel electrode; 20 is a display element; 20a and 20b each are a reflection type display element; 21 is a substantially transparent substrate; 22 is an electrode; 23 is a white electric-charged particle; 24 is a solvent having a blue dye being dissolved therein; 25 is a rotatory particle having an electric-charged surface region; 26 is a dispersion solvent; 100, 100a and 100b each are a display device being visible from both sides.

### DETAILED DESCRIPTION OF THE INVENTION

The present invention realizes a display being visible from both sides. The object of the present invention is to provide a display device being visible from both sides using a substantially transparent semiconductor circuit and a single display element.

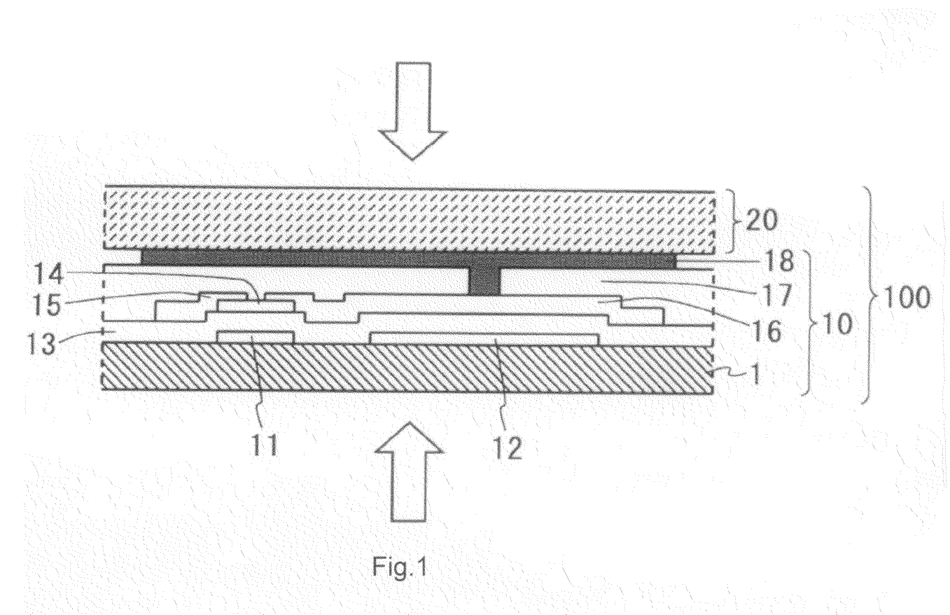

Hereinafter, embodiments of the present invention are described. FIG. 1 is a schematic partial cross-sectional of an example of a display device being visible from both sides of the present invention. The display device being visible from both sides 100 has a substantially transparent semiconductor circuit 10 with a thin film transistor including a source electrode 15, a drain electrode 16, a gate electrode, a semiconductor active layer 14 and a gate insulator 13 over a substantially transparent substrate 1, and a display element 20. A light emitting type display element can be used for the display element 20. If the display element is not a light emitting type, a reflection type can be used. In the case of a transmission type liquid crystal display device which requires a backlight, since the backlight is arranged in a back side of a display element, it is difficult for the display to be visible from both sides. Examples of the light emitting type display elements include an organic EL display and an inorganic EL display. Examples of the reflection type display elements include an electrophoresis display device which is filled with an electric-charged electrophoresis particle dispersed in a dispersion solution, a rotatory particle display device which is filled with a rotatory particle having an electric-charged surface region dispersed in a dispersion solution, and an electron powder fluid type display device which is filled with a powder fluid and in which the powder fluid moves. In the case of the electron powder fluid type display device, a powder fluid which shows a high fluidity in an aerosol state in which a solid type material is stably floated as dispersoid in a gas is used. In this way, the use of a substantially transparent semiconductor circuit 10 and a display element 20 can allow a display device being visible from both sides to be realized where a plurality of display elements are not used.

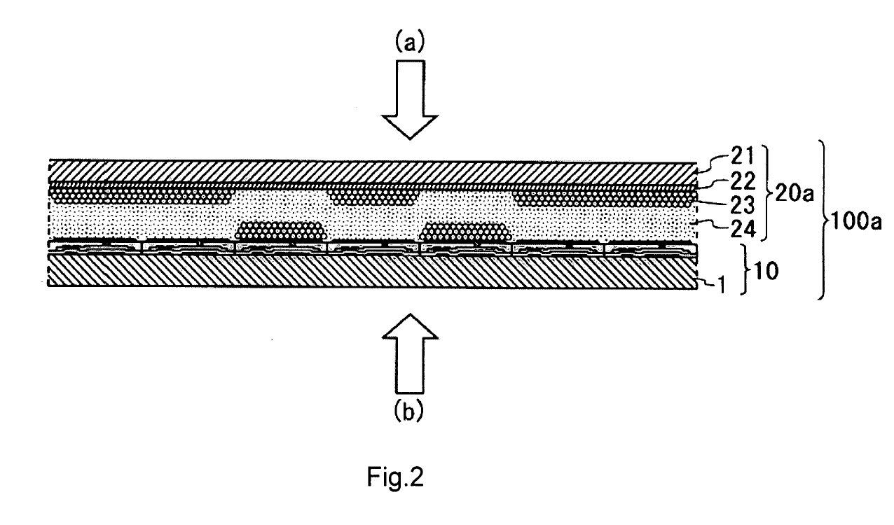

FIG. 2 is a schematic partial cross-sectional diagram of an example of a display being visible from both sides of the present invention, wherein a reflection type display element 20a is used for a display element. The display device being visible from both sides 100a has a substantially transparent semiconductor circuit 10 with a thin film transistor including a source electrode 15, a drain electrode 16, a gate electrode, a semiconductor active layer 14 and a gate insulator 13 over a substantially transparent substrate 1, and a reflection type display element 20a. In this case, an electrophoresis display element which is filled with an electric-charged electrophoresis particle dispersed in a dispersion solution is used. In this way, the use of a substantially transparent semiconductor circuit 10 and a reflection type display element 20a can allow a display device displaying an image and a reversed image thereof on both sides respectively to be realized where a plurality of display elements are not used.

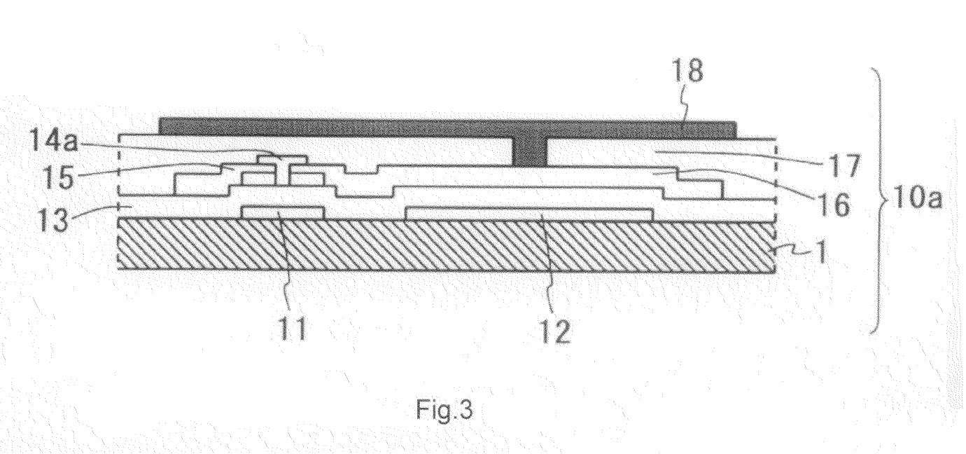

FIG. 3 is a schematic partial cross-sectional diagram of another example of a display device being visible from both sides of the present invention, wherein a reflection type display element 20b is used for a display element. The display device being visible from both sides 100b has a substantially transparent semiconductor circuit 10a with a thin film transistor including a source electrode 15, a drain electrode 16, a gate electrode, a semiconductor active layer 14a and a gate insulator 13 over a substantially transparent substrate 1, and a reflection type display element 20b. In this way, the use of a substantially transparent semiconductor circuit 10a and a reflection type display element 20b can allow a display device displaying an image and a reversed image thereof on both sides respectively to be realized where a plurality of display elements are not used.

In another embodiment, the semiconductor active layer 14 of the thin film transistor included in the substantially transparent semiconductor circuit 10 is manufactured using a material in which a main component is a metal oxide. When a metal oxide semiconductor is used for the semiconductor active layer 14 in this way, a thin film transistor which is transparent and has excellent characteristics can be realized.

In another embodiment, the semiconductor active layer 14a of the thin film transistor included in the substantially transparent semiconductor circuit 10a is manufactured using a material in which a main component is an organic material. When a material including an organic material as a main component is used for the semiconductor active layer 14a in this way, a thin film transistor which is transparent and has excellent characteristics can be realized.

Hereinafter, display devices 100a, 100b being visible from both sides are described in detail. At first, a gate electrode 11, an auxiliary capacitor electrode 12, a gate insulator 13, a semiconductor active layer 14, a source electrode 15 and a drain electrode 16 are formed on a substantially transparent substrate 11, thereby a thin film transistor is formed. A substantially transparent semiconductor 10 is manufactured by forming an interlayer dielectric 17 and a pixel electrode 18. Here, “substantially transparent” means transmittance of 70% or more in the wave length range of 400-700 nm corresponding to a visible light.

For a substantially transparent substrate 11, polymethyl methacrylate, acrylics, polycarbonate, polystyrene, polyethylen sulfide, polyethersulfone, polyolefin, polyethylene terephthalate, polyethylenenaphthalate, cyclo-olefin polymers, polyether sulfone, triacetylcellulose, polyvinyl fluoride film, ethylene-tetrafluoroethylene copolymer resin, weatherable polyethylene terephthalate, weatherable polypropylene, glass fiber-reinforced acryl resin film, glass fiber-reinforced polycarbonate, transparent polyimide, fluorinated resin, cyclic polyolefin resin, glass and quartz can be used concretely. A substrate comprising only one material among the above mentioned materials can be used, but a composite substrate comprising two or more materials among the above mentioned materials can also be used.

In addition, when a substrate 1 is an organic film, it is preferable to form a transparent gas barrier layer in order to raise the durability of the device. Al₂O₃, SiO₂, SiN, SiON, SiC, diamond like carbon (DLC) or the like can be used for the gas barrier layer. In addition, the gas barrier layer may comprise two or more layers. In addition, the gas barrier layer may be formed on only one side of the organic film substrate, and it may be formed on both sides. The gas barrier layer can be formed by an evaporation method, an ion plating method, a sputter method, a laser ablation method, a plasma CVD (Chemical Vapor Deposition) method, a hot wire CVD method and a sol-gel process.

For a gate electrode 11, a source electrode 15, a drain electrode 16, an auxiliary capacitor electrode 12 and a pixel electrode 18, oxide materials such as indium oxide (In₂O₃), tin oxide (SnO₂), zinc oxide (ZnO), cadmium oxide (CdO), cadmium indium oxide (CdIn₂O₄), cadmium tin oxide (Cd₂SnO₄), zinc tin oxide (Zn₂SnO₄) and indium zinc oxide (In—Zn—O) can be used.

In addition, these materials doped with impurities are preferably used. For example, indium oxide doped with tin (Sn), molybdenum (Mo) or titanium (Ti) , tin oxide doped with antimony (Sb) or fluorine (F), zinc oxide doped with indium, aluminium and gallium (Ga) can be used. Among these doped materials, indium tin oxide (common name ITO) which is indium oxide doped with tin (Sn) is preferable used, because ITO has high transparency and low electrical resistivity.

In addition, an electrode having plural layers comprising the above mentioned conductive oxide material and metal thin film such as Au, Ag, Cu, Cr, Al, Mg and Li can be used. For this case, in order to prevent oxidation and time degradation of the metallic material, a three-layer structure, that is, conductive oxide thin film/metallic thin film/conductivity oxide thin film, is preferably used. In addition, a metallic thin film layer should be as thin as possible so as to not disturb visibility of a display device by light reflection and light absorption at a metallic thin film layer. It is particularly desirable to be 1 nm-20 nm. In addition, organic conducting materials such as PEDOT (polyethylen dihydroxy thiophen) can be preferably used.

The materials used in a gate electrode 11, a source electrode 15, a drain electrode 16, an auxiliary capacitor electrode 12, a pixel electrode 18, a scanning line electrode and a signal line electrode, may be identical or all of the materials may be different from each other. In addition, in order to reduce the number of the processes, it is preferable that the materials of a gate electrode and an auxiliary capacitor electrode are identical and the materials of a source electrode and a drain electrode are identical. These transparent electrodes can be formed by a vacuum evaporation method, an ion plating method, a sputter method, a laser ablation method, a plasma CVD technique, photo-CVD, a hot wire CVD method, screen printing, relief printing or an ink jet method.

A coating film is formed using a material of which the main component is a metal oxide as a substantially transparent semiconductor active layer 14. Well-known materials such as zinc oxide, indium oxide, indium zinc oxide, tin oxide, tungsten oxide (WO) and zinc gallium indium oxide (In—Ga—Zn—O) which are oxides including one or more elements among zinc, indium, tin, tungsten, magnesium and gallium can be used as the material of which the main component is a metal oxide. It is desirable that these materials are substantially transparent and the band gap is equal to or more than 2.8 eV, more preferably it is equal to or more than 3.2 eV.

The structure of these materials may be monocrystal, polycrystal, crystallite, mixed crystal of crystal/amorphous, nanocrystal scattering amorphous or amorphous. It is preferable that the film thickness of a semiconductor layer be equal to or more than 20 nm. The oxide semiconductor layer can be formed by a sputter method, a pulsed laser deposition, a vacuum evaporation method, a CVD method, an MBE (Molecular Beam Epitaxy) method and a sol-gel process, however, the sputter method, pulsed laser deposition, vacuum evaporation method and CVD method are preferably used. For the sputter method, a RF magnetron sputtering technique and a DC sputter method can be used. For the vacuum deposition, heating evaporation, electron beam evaporation and a ion plating method can be used, and for the CVD method, a hot wire CVD method and a plasma CVD technique can be used, but usable methods are not limited to these methods.

A coating film is formed using a semiconductor material of which the main component is an organic material as a substantially transparent semiconductor active layer 14a. Acene such as pentacene or tetracene, naphthalene tetracarboxylic dianhydride (NTCDA) and naphthalene tetracarboxylic acid dilmide (NTCDI) or conjugated polymers such as polythiophene, polyaniline, poly-p-phenylenevinylene, polyacetylene, polydiacetylene and polythienylen vinylene can be used for the semiconductor material of which the main component is an organic material. It is desirable that these materials are substantially transparent and the band gap is equal to or more than 2.8 eV, more preferably it is equal to or more than 3.2 eV. These organic semiconductor materials are formed by screen printing, inversion type printing, an ink jet process, spin coat, dip coat and evaporation method.

A material used for gate insulator 13 of a thin film transistor is not especially limited, and inorganic materials such as silicon oxide, silicon nitride, silicon oxy nitride (SiNxOy), aluminium oxide, SIALON, tantalum oxide, yttria, hafnium oxide, hafnium aluminates, oxidation zirconia, titanium oxide or polyacrylates such as PMMA (polymethyl methacrylate), PVA (polyvinyl alcohol), PS (polystyrene), transparent polyimide, polyester, epoxy, poly vinylphenol and polyvinyl alcohol can be used.

In order to control a gate leak current, electrical resistivity of insulating materials should be equal to or more than 10¹¹ Ωcm, and more preferably it should be equal to or more than 10¹⁴ Ωcm. An insulator layer can be formed by a vacuum evaporation method, an ion plating method, a sputter method, a laser ablation method, a plasma CVD technique, photo-CVD, a hot wire CVD method, spin coat, dip coat screen printing or the like. It is desirable that the thickness of an insulator layer be 50 nm-2 μm. These gate insulators may be used as a monolayer. In addition, they may have plural layers. In addition, as for the gate insulator, a composition may slope towards the growth direction of the film.

The structure of the thin film transistor used in the present invention is not especially limited. It may be a bottom contact type or a top contact type. However, when an organic semiconductor is used, a bottom contact type, wherein a gate electrode, a gate insulator, a source electrode and a drain electrode, an organic semiconductor are formed in this order, is preferable. The reason is because a semiconductor layer is damaged in a case where an organic semiconductor layer is exposed to plasma in a process after an organic semiconductor is formed. In addition, the following processes are preferably used in order to raise an aperture ratio: an interlayer dielectric is provided on a thin film transistor used in the present invention; and pixel electrode 18 is provided on interlayer dielectric, wherein pixel electrode 18 is electrically connected to drain electrode 16.

Interlayer dielectric 17 should be substantially transparent and have insulating properties. For example, inorganic materials such as silicon oxide, silicon nitride, silicon oxy nitride (SiNxOy), aluminium oxide, SIALON (SixAlyOzN), tantalum oxide, yttria, hafnium oxide, hafnium aluminates, zirconia oxide and titanium oxide, and polyacrylates such as PMMA (polymethyl methacrylate), PVA (polyvinyl alcohol), PS (polystyrene), transparent polyimide, polyester, epoxy, poly vinylphenol, polyvinyl alcohol or the like can be used, but usable materials are not limited to these materials. An interlayer dielectric may be formed by the same material as a gate insulator, and it may be formed by a material different from a gate insulator. These interlayer dielectrics may be used as a monolayer, and these interlayer dielectrics comprising plural layers may also be used.

In the case of a device having a bottom gate structure, a protection film covering a semiconductor layer is preferably formed. A protective film can prevent a semiconductor layer from changing with time due to humidity and can prevent a semiconductor layer from being influenced by an interlayer dielectric. Inorganic materials such as silicon oxide, silicon nitride, silicon oxy nitride (SiNxOy), aluminium oxide, SIALON (SixAlyOzN), tantalum oxide, yttria, hafnium oxide, hafnium aluminates, zirconia oxide, titanium oxide, and, polyacrylates such as PMMA (polymethyl methacrylate), PVA (polyvinyl alcohol), PS (polystyrene), transparent polyimide, polyester, epoxy, poly vinylphenol, polyvinyl alcohol and fluorinated resin can be used as a protection film, but usable materials are not limited to these materials. These protection films may be used as a monolayer, and these protection films comprising plural layers may also be used.

In the present invention, a pixel electrode 18 is electrically connected with a drain electrode 16 of the thin film transistor. Specific embodiments are illustrated below. An interlayer dielectric 17 in a part of drain electrode 16 can be not formed by forming a pattern-shaped interlayer dielectric by a method such as screen printing. After having applied the interlayer dielectric to the entire area, a hole can be formed in the interlayer dielectric by a laser beam.

A thin film transistor is formed by forming a gate electrode 11, an auxiliary capacitor electrode 12, a gate insulator 13, a semiconductor active layer 14, a source electrode 15 and a drain electrode 16 on the above-mentioned substantially transparent substrate 1. Thereafter, a substantially transparent semiconductor circuit 10 is formed by forming an interlayer dielectric 17 and a pixel electrode 18. An electrophoresis type display 20a in which a white type electric-charged fine particle 23 is dispersed in a solvent 24 including a dissolved blue dye is arranged on a semiconductor circuit 10. In this way, a display device 100a being visible from both sides with a reflection type display element 20a as a display element can be obtained. (See FIG. 2.)

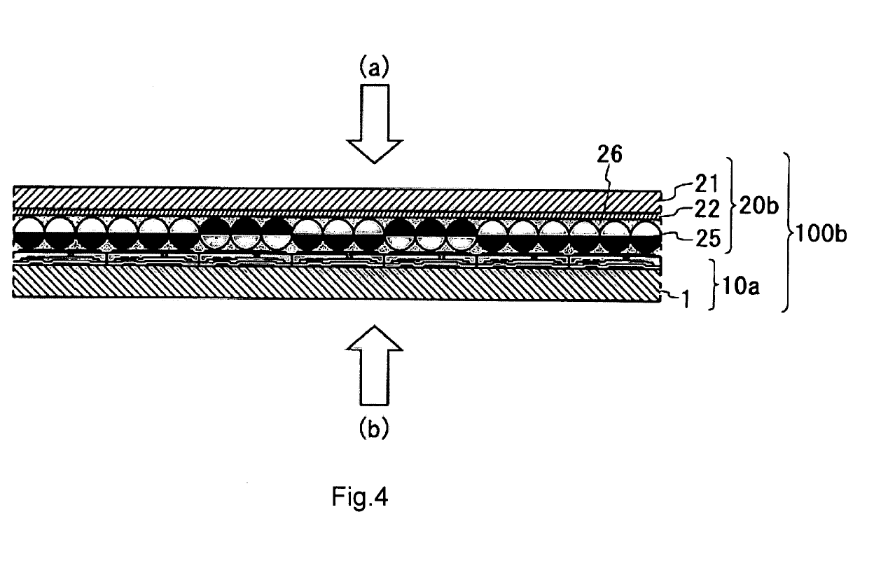

Further, a thin film transistor is formed by forming a gate electrode 11, an auxiliary capacitor electrode 12, a gate insulator 13, a semiconductor active layer 14a, a source electrode 15 and a drain electrode 16 on the above-mentioned substantially transparent substrate 1. Thereafter, a substantially transparent semiconductor circuit 10a is formed by forming an interlayer dielectric 17 and a pixel electrode 18. A reflection type display element 20b comprising a white-black Twisting Ball type electric display is arranged on a semiconductor circuit 10a. In this way, a display device 100b being visible from both sides with a reflection type display element 20b as a display element can be obtained. (See FIG. 4.)

According to the present invention, a display device being visible from both sides without a plurality of display elements can be realized by the use of a substantially transparent semiconductor circuit and a display element driven by the semiconductor circuit. In addition, the use of a reflection type display element as a display element can allow an image and a reversed image thereof to be displayed on both sides respectively. In addition, in the case of light emitting type display, the same image can be observed from both sides.

### EXAMPLE 1

At first, ITO thin film having a thickness of 50 nm was formed on one surface of a substantially transparent substrate 1 comprising alkali-free glass 1737 (thickness 0.5 mm) made in Corning by DC magnetron sputtering. Further, patterning was performed, thereby ITO thin film having a desired shape was formed. A gate electrode 11 and an auxiliary capacitor electrode 12 were formed.

Next, a gate insulator 13 of 200 nm thickness comprising a SiON thin film was formed by RF sputter using silicon nitride (Si₃N₄) as a target.

Next, an amorphous In—Ga—Zn—O thin film of 40 nm thickness was formed by RF sputter using a InGaZnO⁴ target. After patterning was performed, a semiconductor active layer 14 having a desired shape was formed.

Next, a photosensitive layer was formed by applying a resist. Patterning processes such as patterned-exposure and development were performed, thereby a resist pattern used for a lift-off method was formed. Further, ITO film of 50 nm thickness was formed by DC magnetron sputtering using the resist pattern as a mask. ITO film on the resist pattern was removed using a predetermined chemical liquid by a lift-off process. Thereby, a source electrode 15 and a drain electrode 16 were formed.

Next, a pattern of an epoxy type resin solution was formed by a printing method, thereby an interlayer dielectric 17 of 5 mm thickness was formed. Further, ITO film of 100 nm thickness was formed by a magnetron sputter method. A pixel electrode 18 was formed by a patterning process. Thereby, a substantially transparent semiconductor circuit 10 was manufactured.

Table 1 shows conditions in formation of respective films.

TABLE 1

| | | Ar flow rate | O₂ flow rate | Operating | Input |
|---|---|---|---|---|---|
| | target | SCCM | SCCM | pressure Pa | power W |
| Gate electrode | SnO₂:5 wt %—In₂O₃ | 10 | 0.25 | 0.75 | 200 |
| and auxiliary | | | | | |
| capacitor | | | | | |
| electrode | | | | | |
| Gate insulator | Si₃N₄ | 40 | 2 | 0.5 | 200 |
| Semiconductor | InGaZnO | 10 | 0.2 | 0.5 | 200 |
| active layer | | | | | |
| Source and | SnO₂:5 wt %—In₂O₃ | 10 | 0.25 | 0.75 | 200 |
| drain electrodes | | | | | |
| Pixel electrode | SnO₂:5 wt %—In₂O₃ | 10 | 0.25 | 1.0 | 50 |

Next, electrophoresis type display 20a in which a white electric-charged fine particle 23 was dispersed in a solvent 24 including a dissolved blue dye was arranged on a semiconductor circuit 10. In this way, a display device 100a being visible from both sides using a reflection type display element 20a as a display element was obtained. (See FIG. 2.)

### EXAMPLE 2

At first, a titanium thin film of 40 nm thickness was formed on one surface of a substantially transparent substrate comprising a PEN film (Q65; a product of TEIJIN) of 125 μm thickness by RF magnetron sputtering. Further, patterning process of the titanium thin film was performed so that the titanium thin film had a desired shape, thereby a gate electrode 11 and an auxiliary capacitor electrode 12 were formed.

Next, poly vinylphenol was applied by a spin coating. A gate insulator 13 of 1 mm thickness was formed by heating and drying the poly vinylphenol.

Next, a metal film was formed by an evaporation method. Patterning processes such as application of a resist, drying, patterned-exposure, development and etching were performed, thereby a source electrode 15 and a drain electrode 16 were formed. Further, a semiconductor active layer 14a comprising a pentacene thin film was formed by a evaporation method using a mask.

Next, a pattern of an epoxy type resin solution was formed by a printing method, thereby an interlayer dielectric 17 of 5 mm thickness was formed. Further, ITO film of 150 nm thickness was formed by a magnetron sputter method. A pixel electrode 18 was formed by a patterning process. Thereby, a substantially transparent semiconductor circuit 10a was manufactured. (See FIG. 3.)

Next, a reflection type display element 20b comprising a white-black Twisting Ball type electric display was arranged on a semiconductor circuit 10a. In this way, a display device 100b being visible from both sides using a reflection type display element 20b as a display element was obtained. (See FIG. 4.)

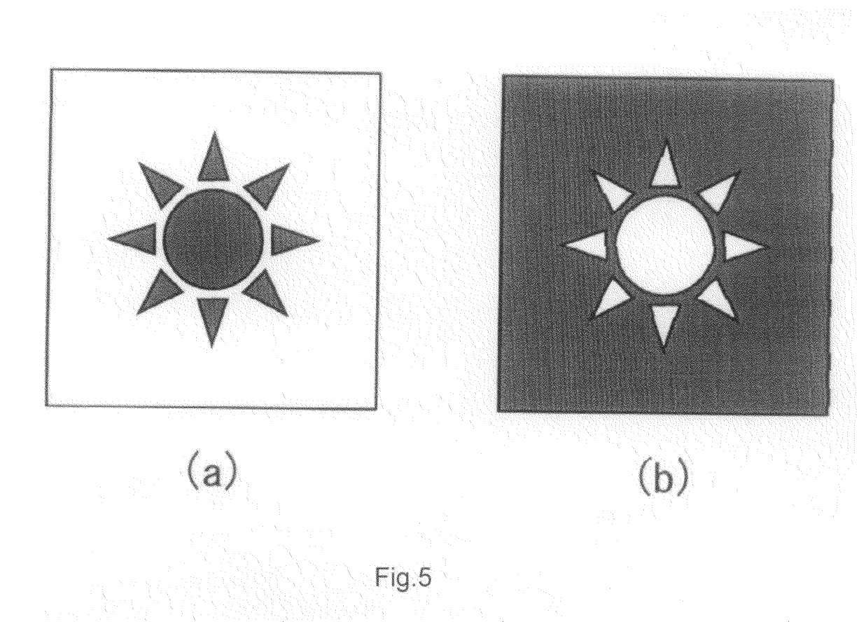

In FIGS. 5(a) and (b), an example of displayed images when a display device being visible from both sides of the present invention was used is shown. FIG. 5(a) is an explanatory figure of an example of a displayed image, the image being obtained by observing a display device being visible from both sides of the present invention from a direction (a). FIG. 5(b) is an explanatory figure of an example of a displayed image, the image being obtained by observing a display device being visible from both sides of the present invention from a direction (b). If the image of FIG. 5(a) is defined as a positive state image, the image of FIG. 5(b) is a negative state image. The display device can display the two images.

(The disclosure of Japanese Patent Application Ser. No. JP 2006-256995, filed on Sep. 22, 2006, is incorporated herein by reference in its entirety.)

What is claimed is:

1. A display device being visible from both sides, comprising:
a substantially transparent semiconductor circuit having:
a substantially transparent thin film transistor on one surface of a substantially transparent substrate;
a wiring made of a substantially transparent conductive material, said wiring having an electric contact point electrically connected to said transistor; and
a display element being driven by said semiconductor circuit.

2. The display device being visible from both sides according to claim 1, wherein said display element includes a reflection type display element.

3. The display device being visible from both sides according to claim 1, wherein said display element includes a light emitting type display element.

4. The display device being visible from both sides according to claim 1, wherein there is only one display element.

5. The display device being visible from both sides according to claim 1, wherein said thin film transistor includes a source electrode, a drain electrode and a gate electrode, a semiconductor active layer and a gate insulator, and wherein said semiconductor active layer includes a material in which a main component is a metal oxide.

6. The display device being visible from both sides according to claim 1, wherein said thin film transistor includes a source electrode, a drain electrode and a gate electrode, a semiconductor active layer and a gate insulator, and wherein said semiconductor active layer includes a material in which a main component is an organic material.
